(19) United States
(12) Patent Application Publication
(10) Pub. No.: US 2025/0238761 A1
(43) Pub. Date: Jul. 24, 2025

(54) UNSTRUCTURED INFORMATION TO STRUCTURED DATA TRANSLATOR WITH GRAPHICAL USER INTERFACE

(71) Applicant: The Machine, LLC, New York, NY (US)

(72) Inventors: Jeff Rinehart, New York, NY (US); Josh Cohen, New York, NY (US); Rohan Nair, New York, NY (US)

(21) Appl. No.: 18/421,817

(22) Filed: Jan. 24, 2024

(51) Int. Cl. G06Q 10/107; G06F 16/25; G06F 40/205; G06F 40/295; G06Q 40/06

(52) U.S. Cl. CPC G06Q 10/107; G06F 16/258; G06F 40/205; G06F 40/295; G06Q 40/06

(57) ABSTRACT

Embodiments of the present invention provide a novel approach to investment analysis that can automatically accumulate a large amount of relevant company information that can be readily parsed and presented on a dashboard or similar display to support decision making, tracking, and analysis for the purposes of investment in companies and other entities. Some embodiments are tailored to enable firms to easily transform unstructured information into structured (e.g., row/column) data. The transformations are highly accurate and designed to fit seamlessly into an investor's daily workflow (e.g., a private investor, investment firm employee, fund manager or team member, etc.). The resulting structured data can be stored in any suitable format (e.g., Excel, Google Sheet, csv, database, etc.), and can be updated automatically as more information becomes available.

### CROSS-REFERENCE TO RELATED APPLICATIONS

The present application is related to copending U.S. patent application Ser. No. 18/416,786, filed Jan. 18, 2024 and having attorney docket number CTYL-0001-01.01US, which is herein incorporated by reference in its entirety for all purposes.

### FIELD

Embodiments of the present invention generally relate to the field of investment, financial planning, or analysis. More specifically, embodiments of the present invention relate to tools for the management and display of information for financial planning and investment.

### BACKGROUND

Existing approaches to private-sector investment in companies, including startups, require a substantial investment of time and human resources to identify companies that meet certain requirements or preferences based on financial planning and manual analysis of vast amounts of data. There are typically thousands of potential entities that private-sector investment firms can target for investment, with new companies being created every day. Investing in these companies typically involves accumulating and parsing information about those companies. The information needs to be updated as new, relevant data becomes available. For example, new investment targets can be analyzed based on initial meetings with companies, presentations (e.g., company overview) or other diligence materials produced during the course of researching a company. Companies that are currently part of a firm's investment portfolio may be further analyzed based on investor update emails, check-ins, and meetings, such as board meetings, periodic calls, etc. News publications and other public databases are often sourced, as well.

While these approaches to investment analysis and monitoring can accumulate a large amount of relevant information, the information is typically unstructured and cannot be automatically aggregated into actionable information that can be used for spotting trends, outliers, etc. Accordingly, a more advanced approach to acquiring, structuring, and presenting company information is desired.

### SUMMARY

Accordingly, embodiments of the present invention provide a novel approach to investment analysis that can automatically accumulate a large amount of relevant company information that can be readily parsed and presented on a dashboard or similar display to facilitate deal-flow management and investment in companies and other entities. Some embodiments are tailored to enable firms to easily transform unstructured information into structured data using any suitable format. Company information can be sourced from various forms of interaction, both public and private, such as newsletters, press releases, investment APIs, private meetings, emails, etc. The meetings can include interactions between founders, board members, etc.). The transformations are highly accurate and designed to fit seamlessly into an investor's daily workflow (e.g., a private investor, investment firm employee, fund manager or team member, etc.). The resulting structured data can be stored in any suitable row/column format (e.g., Excel, Google Sheet, csv, database, etc.), and can be updated automatically as more information becomes available. According to some embodiments, the extracted information is parsed, combined with existing data (public and private), analyzed, and displayed on an interactive graphical user interface (e.g., a customizable dashboard).

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary on-screen GUI of a portfolio dashboard displaying information pertaining to a portfolio of companies that a user or investor is currently invested in according to embodiments of the present invention.

FIGS. 2A and 2B depict an exemplary on-screen GUI showing a company-level view for investment analysis according to embodiments of the present invention.

FIG. 3 depicts an exemplary on-screen GUI for creating a new note according to embodiments of the present invention.

FIG. 4 depicts an exemplary on-screen GUI for displaying a submitted note according to embodiments of the present invention.

FIG. 5 is a flowchart depicting an exemplary process for transforming notes or other textual information into structured data according to embodiments of the present invention.

FIG. 6 depicts an exemplary on-screen GUI for displaying note information (e.g., meeting note information) that has been submitted and processed according to embodiments of the present invention.

FIG. 7 is a flowchart depicting an exemplary process for transforming emails or other textual information into structured data according to embodiments of the present invention.

FIGS. 8A and 8B depict an exemplary on-screen GUI for displaying company information that has been extracted from one or more emails and processed according to embodiments of the present invention.

FIG. 9 depicts an exemplary on-screen GUI showing deal notes for various companies categorized including non-portfolio companies according to embodiments of the present invention.

FIG. 10 depicts an exemplary on-screen GUI for entering a new deal note for a non-portfolio company (a company the firm or user is not currently invested in) according to embodiments of the present invention.

FIG. 11 depicts an exemplary on-screen GUI displaying submitted and processed meeting note information for a non-portfolio company according to embodiments of the present invention.

FIG. 12 is a flowchart depicting steps of an exemplary process for automatically structuring data from meeting notes pertaining to non-portfolio companies according to embodiments of the present invention.

FIG. 13 depicts an exemplary computer system upon which embodiments of the present invention can be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

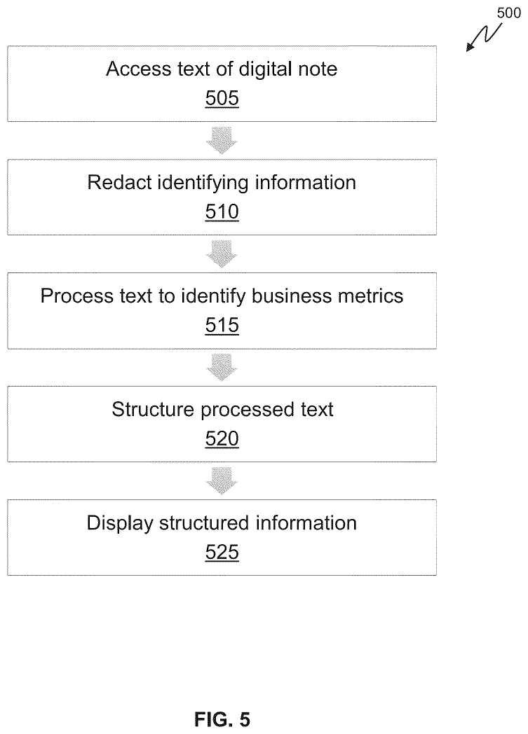

Portions of the detailed description that follow are presented and discussed in terms of a method. Although steps and sequencing thereof are disclosed in a figure herein (e.g., FIGS. 5, 7, and 12) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “configuring,” “coordinating,” “storing,” “transmitting,” “authenticating,” “identifying,” “requesting,” “reporting,” “determining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Novel Structured Data Translator and Graphical User Interface

Embodiments of the present invention provide a novel approach to investment analysis that can automatically accumulate a large amount of relevant company information that can be readily parsed and presented on a dashboard or similar display for deal-flow management and investment in companies and other entities. Some embodiments are tailored to enable firms to easily transform unstructured information into structured (e.g., row/column) data. The transformations are highly accurate and designed to fit seamlessly into an investor's daily workflow (e.g., a private investor, investment firm employee, fund manager or team member, etc.). The resulting structured data can be stored in any suitable row/column format (e.g., Excel, Google Sheet, csv, etc.), and can be updated automatically as more information becomes available.

As described in the related application CTYL-0001-01.01 referenced above, one aspect of the present invention involves an AI-driven approach to sorting through hundreds of thousands of companies periodically (e.g., one per week, once per month, etc.) and performing analytical assessment on each company that potentially fits certain predefined investment criteria. The identified companies (“recommended companies”) can then be provided to an investor or team members (e.g., employees of an investment firm, an account manager, etc.). Companies can also be identified using more conventional means, like recommendations from a network of resources (peers, consultants, etc.), company research, conferences, meeting notes, etc. Combining these different sources using an AI-driven sorting approach typically yields hundreds of companies for further review each month. This large volume of information leads to a potentially time-consuming process, especially when the information is somewhat informal and lacks clear, concise, and complete information that is readily actionable for making a confident assessment.

Accordingly, embodiments of the present invention can automatically ingest potential candidate companies for further review from any data source, including conference attendee lists, networked-sourced deals, third-party recommendation lists, etc., as long as the basic information for each company can be organized in a row-column format (csv, Excel, Google Sheet, etc.). Moreover, embodiments of the graphical user interfaces disclosed herein can be used to present company information using automatically aggregated and updated data in a way that is easily digestible based on the accumulated data. Any data that is transformed inaccurately can be manually corrected by a user, and the corrected data can be provided to the transformation engine, typically an AI-driven transformation engine, such as a learned language model (LLM), which can help improve the accuracy of the transformation engine.

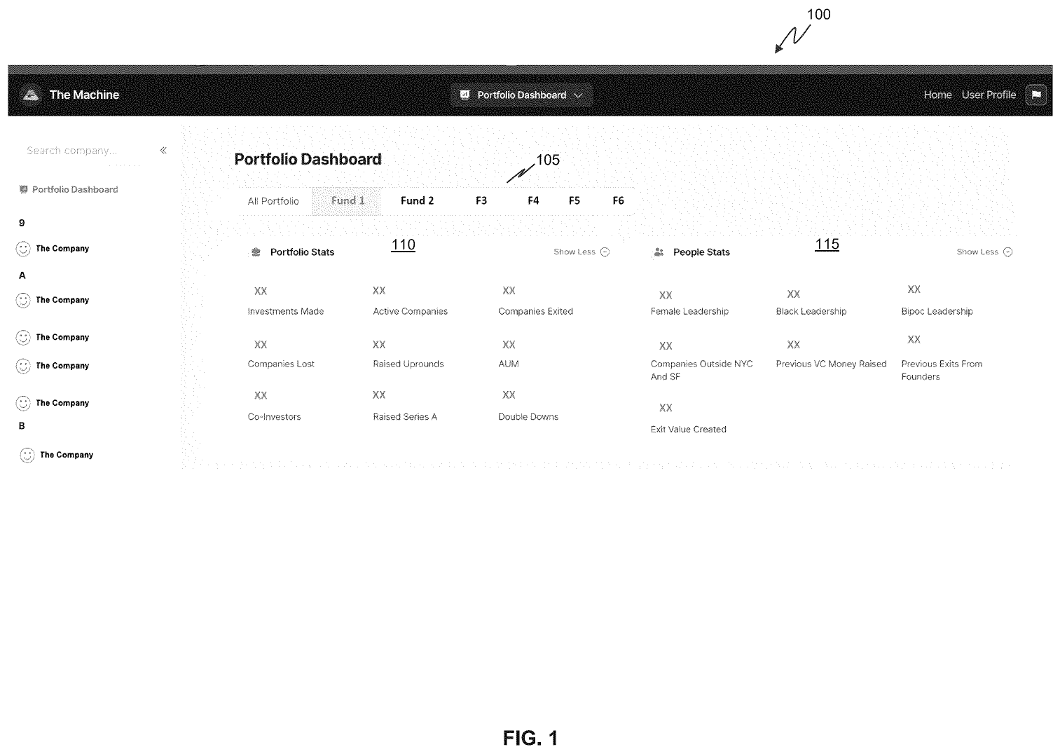

FIG. 1 depicts an exemplary on-screen GUI 100 of a portfolio dashboard displaying information pertaining to a portfolio of companies that a user or investor is currently invested in according to embodiments of the present invention. The portfolio information displayed in FIG. 1 aggregates data from multiple companies, which can be sourced from previously ingested information that has been automatically transformed by a translator or AI-based transformation engine (e.g., an LLM) into a row and column information that can be aggregated, updated, and parsed to spot trends and analyze companies and markets in detail.

Deal flow management information is displayed and controlled using a custom user interface that implements an AI-driven analytic investment process. In this way, the process of initiating deals with target companies and beginning a dialog for potential investment (“deal flow”) can be managed by fewer people using fewer resources. Exemplary GUIs are disclosed herein that can be used to manage and review processes and tasks of team members efficiently and effectively, and to manage deal flow until connections with selected companies are complete.

The high-level graphical user interface 100 depicted in FIG. 1 can be organized and summarized in any way a firm would find useful. In the example of FIG. 1, information pertaining to multiple funds e.g., Funds 1-6 (105) managed by a firm with investments in multiple companies can be displayed, and particular funds or companies can be selected for more detailed information, including portfolio stats 110 and people stats 115. The companies and summary metrics are updated when a fund is selected.

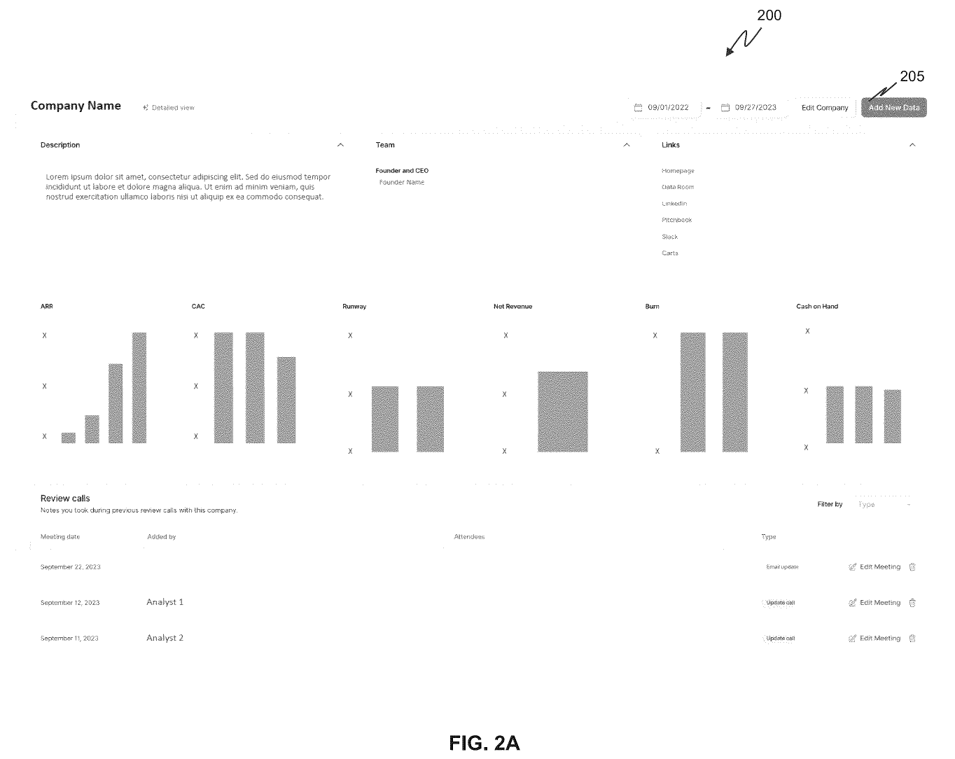

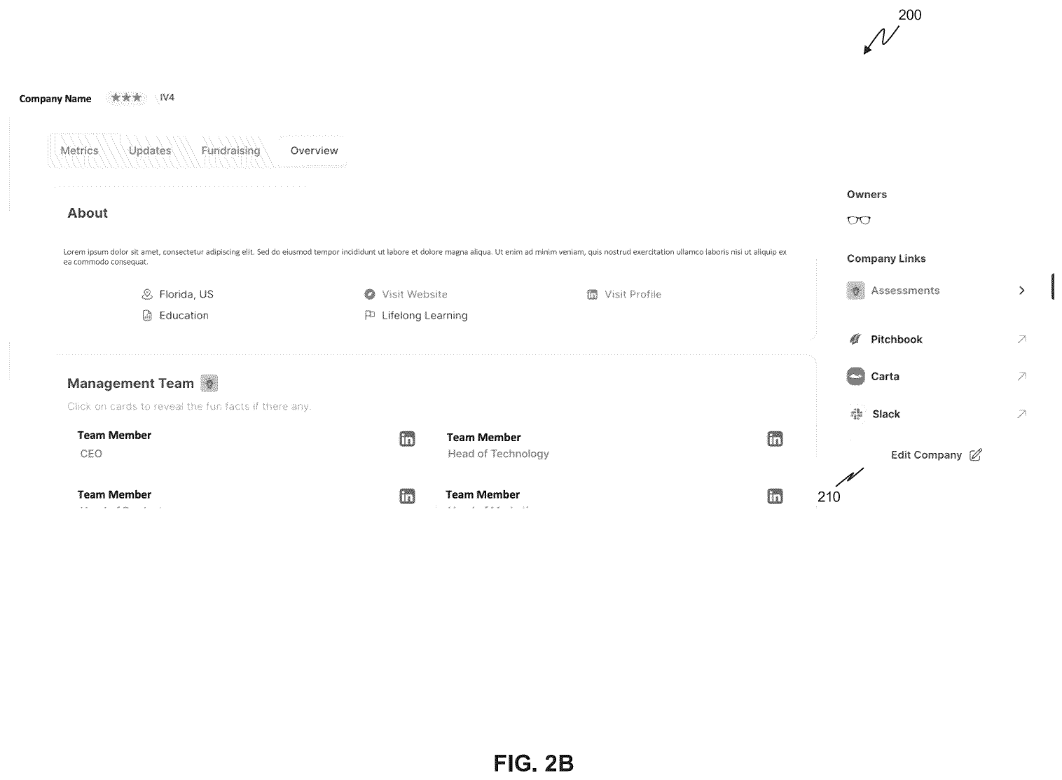

More information can be added at any time, such as when a user or team member attends a meeting with one of the companies under a portfolio or fund. The meeting notes produced by the team member can be ingested and transformed into data. For example, a specific company can be selected using the search bar to open a company-level view, as depicted in the examples of FIGS. 2A and 2B.

FIG. 2A and FIG. 2B depict an exemplary on-screen GUI 200 showing a company-level overview for investment analysis according to embodiments of the present invention. In FIG. 2A, GUI 200 is configured to display a summary view pertaining to the selected company, such as a general description, sector, subsector, graphs of key data points, board composition, links to team profiles, location, website, LinkedIn profile, fundraising information (including cap tables), etc. GUI 200 can also display the history of all meetings and email updates recorded for that company. A new meeting note can be created by selecting the add new data button 205. In the example of FIG. 2B, GUI 200 is configured to show the company owners, company links, management team information, and can display any other items a firm might find useful. Company information can be edited manually by selecting edit company button 210.

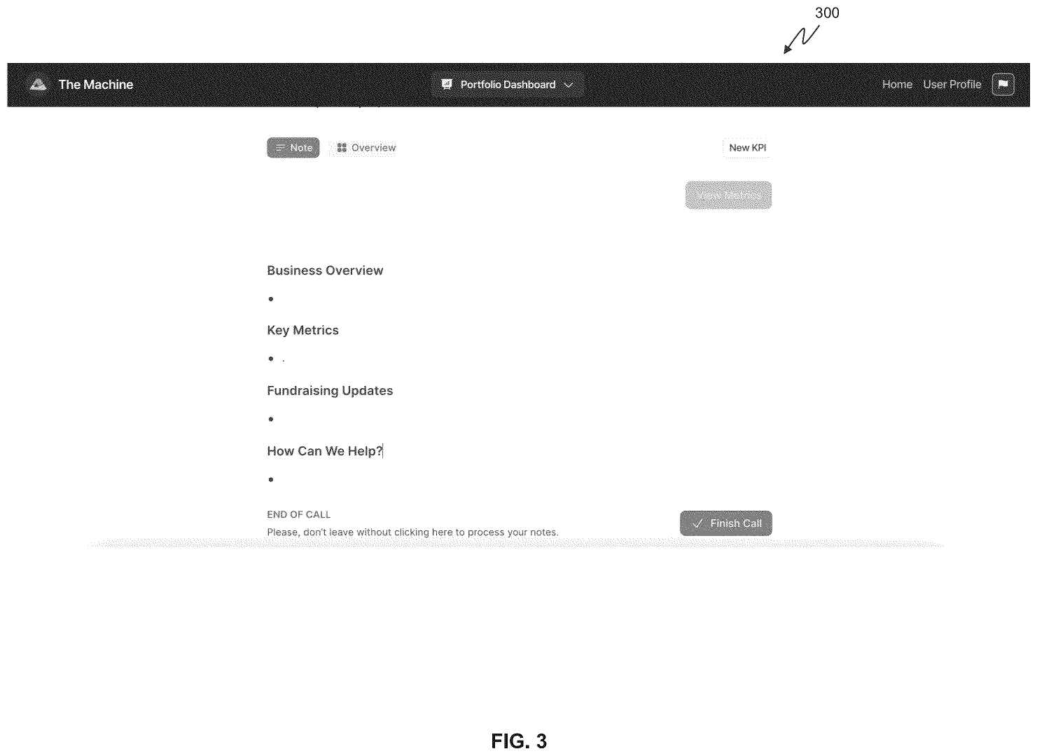

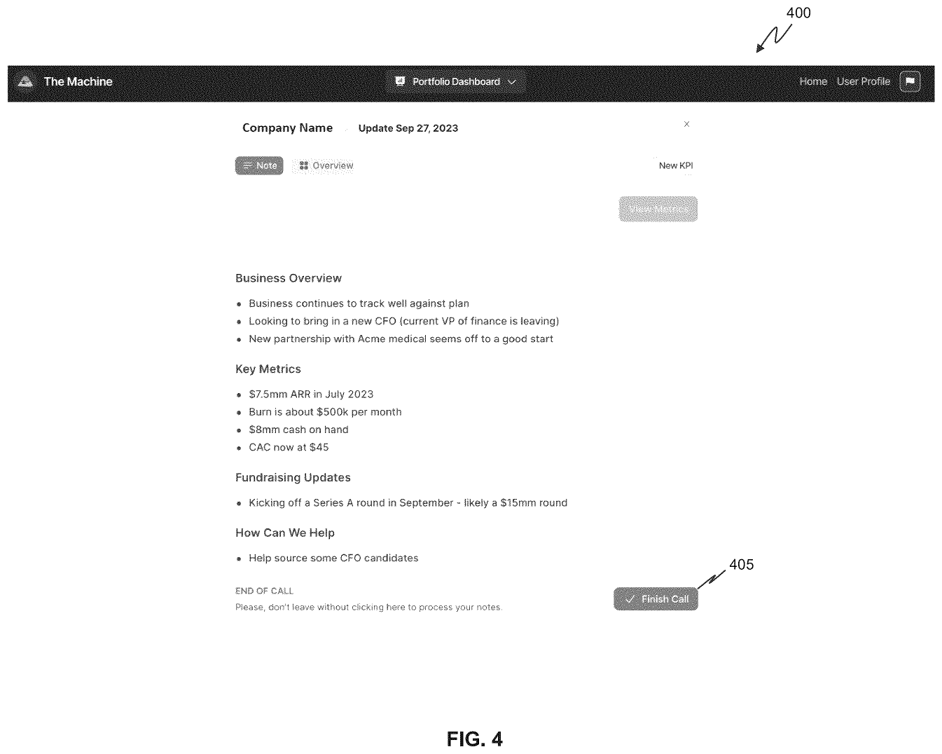

As depicted in FIG. 3, a new note (e.g., meeting note) can be created using on-screen GUI 300 by, according to embodiments. The note form can be pre-structured with different sections in any format desired. In the example above, GUI 300 is structured for note entry using pre-configured Business Overview, Key Metrics, Fundraising, Updates, and How Can We Help sections. The user can enter the relevant information into any of the displayed sections, and the information entered is automatically parsed and, if applicable, integrated into previously transformed company information using a row and column format, for example. FIG. 4 shows an exemplary GUI 400 displaying note sections after text has been entered by a user, according to embodiment. Any necessary changes to the information can be entered directly by the user, and the user can select the finish call button 405 to submit the information for ingestion and/or transformation into the existing data set.

FIG. 5 is a flowchart depicting an exemplary computer-controlled process 500 for transforming notes or other textual information into structured data according to embodiments of the present invention. At step 505, text from a digital note or the like is accessed (e.g., ingested). The text can be entered manually using GUI 300 depicted above, for example. At step 510, information that can be used to identify a company can be removed. This can include company names, addresses, contact information, employee names, etc. At step 515, the remaining information is processed (e.g., transformed) using a customized AI-driven process, such as a custom (“fine-tuned”) version of OpenAI's LLM ChatGPT, although any comparable LLM with fine-tuning can be used. The processing of step 515 includes identifying preconfigured business metrics of interest, and fine-tuning to refine the processing accuracy, such as providing incorrectly transformed data that is manually identified and/or corrected by a user. Moreover, a user can manually identify key performance indicators (KPI) associated with a company that are especially useful when evaluating a company for potential investment. These and other metrics can be used to fine tune the AI-driven processing and transformation, according to embodiments. For example, some embodiments further identify information pertaining specifically to upcoming fundraising rounds and other useful financial information. At step 520, the processed information and data points (e.g., key metrics) are organized in a structured (e.g., row/column) format that can be stored in any format suitable format. Step 520 can further include integrating/updating existing information that has already been ingested and processed. At step 525, the key metrics ingested and transformed during process 500 are displayed, for example, using one of the graphical user interfaces disclosed herein.

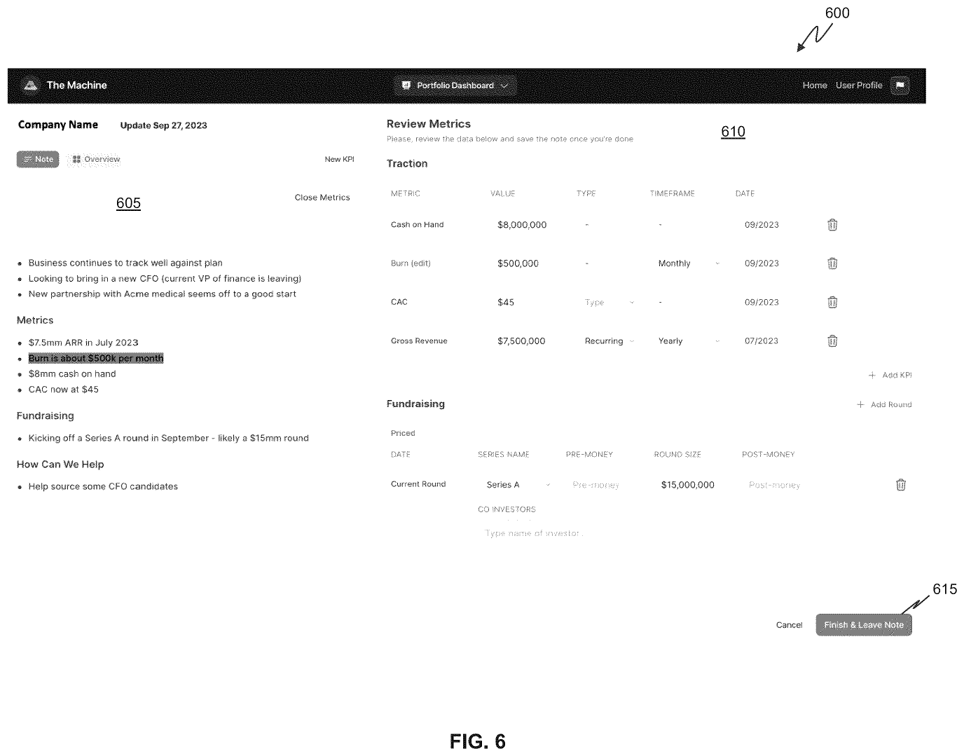

FIG. 6 depicts an exemplary on-screen GUI 600 for displaying note information (e.g., meeting note information) that has been submitted and processed according to embodiments of the present invention. The note information can be submitted and processed using process 500 described above, for example. As depicted in FIG. 6, the information entered in the note is viewable in the left pane 605, and the metrics extracted and transformed into structured data are depicted in right pane 610. When the user interacts with (e.g., hovers over) the metrics shown on the right side, the portion of the note that generated the metrics is highlighted. Importantly, the extraction algorithm is able to identify the time period the metric is relevant to (e.g., July 2023), as well as any relevant items related to current and past fundraising rounds, including the type, size, and valuation of a fundraising round and the participating investors. In this way, the user can quickly and easily review the extracted metrics, and manually make corrections to any information that was not processed correctly. These manual corrections can be fed back to the extraction algorithm to improve and “fine tune” the extraction algorithm, which can include machine learning, a neural net, a LLM, etc. When the note is complete and the data has been extracted correctly, the user can select the finish note button 615. The metrics are then stored in a structured format (row/column) in a data repository, such as a database, spreadsheet, etc., and can be displayed on any of the graphical user interfaces described herein, for example.

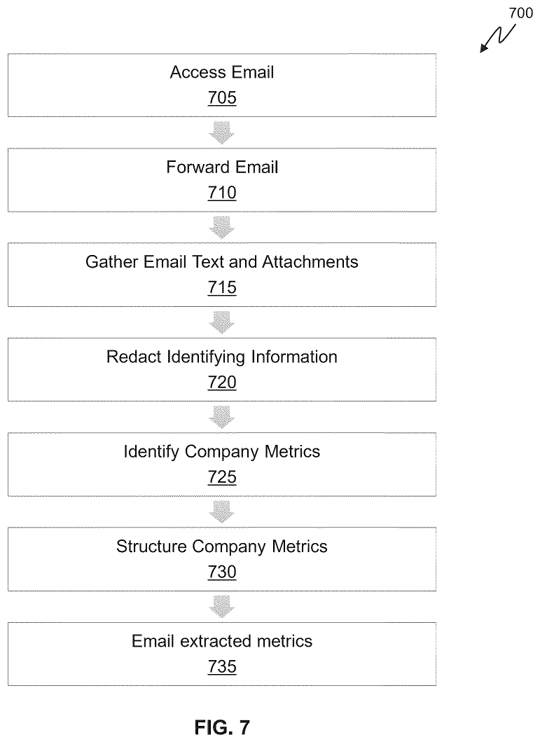

FIG. 7 is a flowchart depicting an exemplary process 700 for transforming emails or other textual information into structured data according to embodiments of the present invention. Investment firms often receive unstructured information regarding their existing portfolio companies through things like investor update emails. Company founders will often use these updates as a way to keep all of the investors apprised of the most recent company status. The updates can come in many different formats, which can make parsing and storing the data contained in those updates difficult. For example, the update may be fully written out in email body text, or may be included in an attachment, such as a PDF, Word document, Google doc, Excel spreadsheet, etc. Other information might be included in items pasted in the email depicting a table of company financials or a graph of revenue over time, for example. Advantageously, embodiments of the present invention can identify those key business data points distributed via email in any given format.

Specifically, at step 705, an email (e.g., an investor update email) including text, images, or other attachments is accessed. At step 710, the email can optionally be forwarded to an email address owned by the firm that has been set up to receive these types of email updates (e.g., portfolio@firm.com). At step 715, the information contained in the text of the email body and any images or attachments are automatically gathered and prepared for processing. At step 720, any information that can be used to identify a company can be redacted. After the identification information has been redacted, at step 725, the remaining information is processed using a highly customized (“fine-tuned”) AI-driven translation algorithm (e.g., an LLM) to identify any information that might be a business metric of interest to the user/firm. The metrics can include but are not limited to key metrics, annual sales, revenue, burn rate, company name, founding date, location, general description, mission statement, social media links, official website, funding information, founder information, company demographics, contact information, website traffic/conversion rates, cash on hand, gross revenue, net revenue, gross margin, customer acquisition costs, upcoming funding rounds, etc.

At step 730, the company metrics are organized in structured (e.g., row/column) format that can be stored in any format a firm would like, such as a database or spreadsheet. As described above, “fine tuning” is performed to refine the base-model's accuracy when identifying and returning important financial metrics. The fine-tuned model can also identify information pertaining to upcoming fundraising rounds, according to embodiments.

At step 735, according to some embodiments, an email including a link to review all company metrics that were extracted from the email can automatically be sent to a user or team member. For example, the link can either be sent immediately post-processing, or the links can be consolidated over time and sent together e.g., once per week or per month, or after a certain number of links have been accumulated. According to some embodiments, the extracted company metrics are displayed in a split screen view to facilitate editing of the information prior to saving the information into the database.

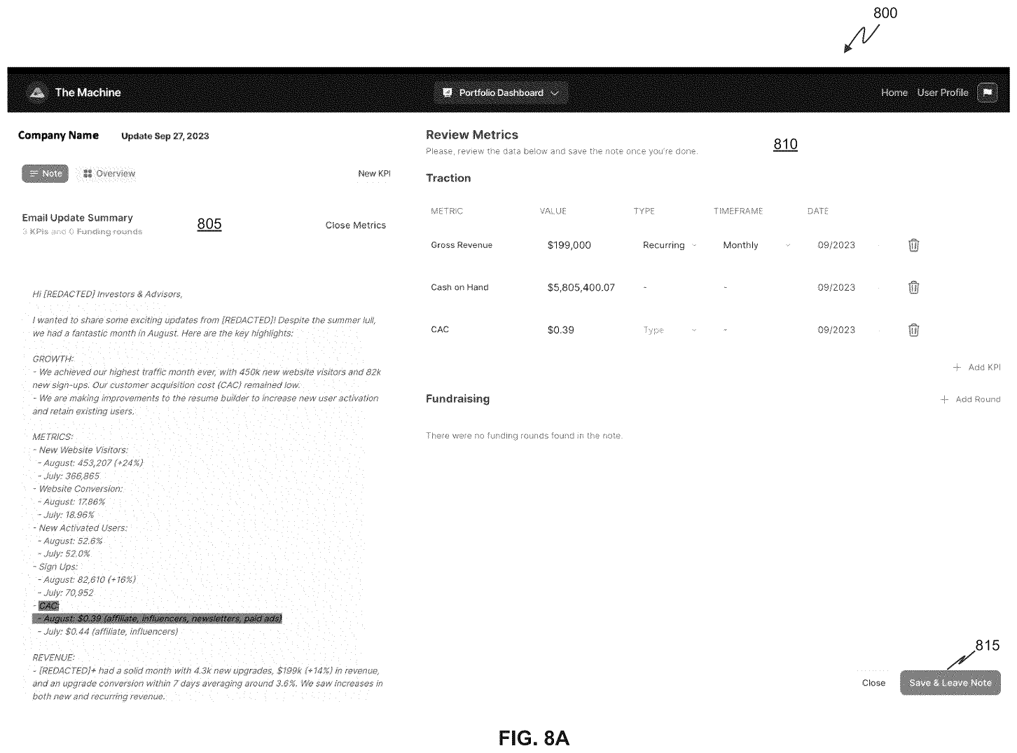

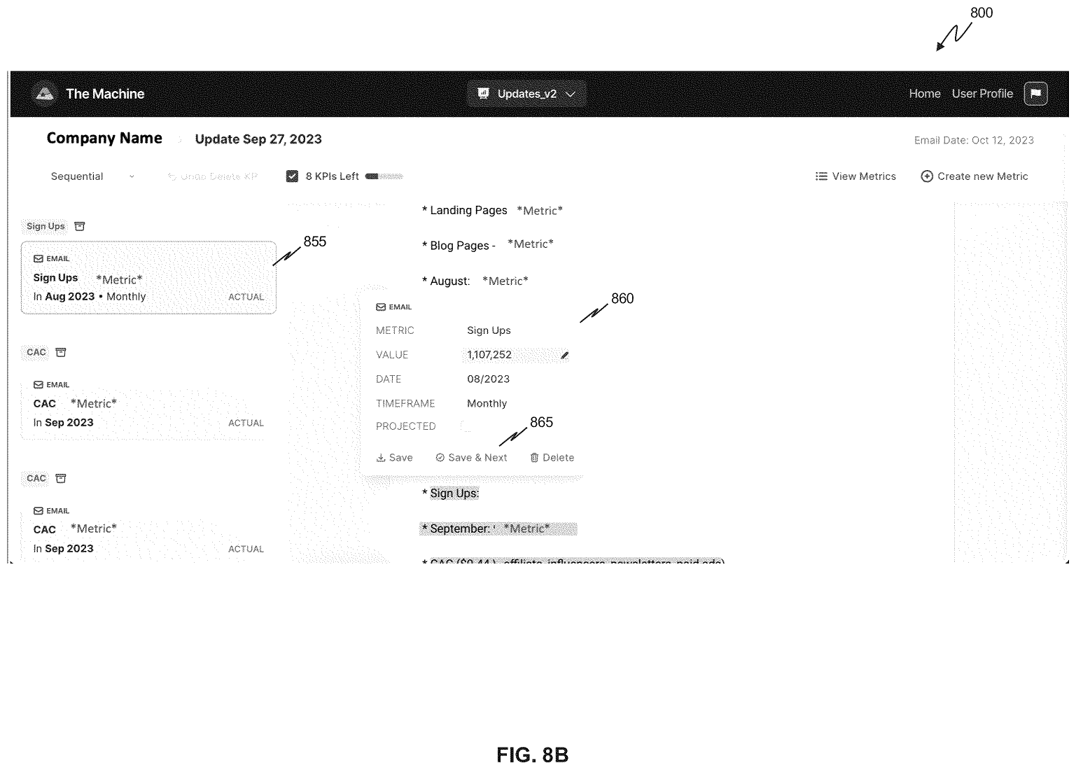

FIG. 8A depicts an exemplary on-screen GUI 800 for displaying company information that has been extracted from one or more emails and processed according to embodiments of the present invention. Similar to GUI 600 depicted above, a user can hover over extracted metrics and the technology in left pane 805 to highlight where the metric was extracted from. The user can then edit, change or add metrics manually using the right pane 810. Once a user is satisfied with the returned metrics, they can click save and leave note button 815. At that point, the metrics are stored in a structured format (e.g., row/column) in the corresponding file or database, and the newly updated information can be displayed by the GUIs described here. Any changes made to the metrics manually by the user can be used to fine-tune the transformation model which can help improve the accuracy of future results.

FIG. 8B depicts exemplary on-screen GUI 800 for displaying company information that has been extracted from one or more emails and processed according to embodiments of the present invention. In the example of FIG. 8B, GUI 200 is configured to display email text 855 with company metrics highlighted in line. The user can then directly edit, change, or add metrics manually using in line pop up 860 by selecting a specific email or other communication that includes or potentially includes metrics of interest. Once a user is satisfied with the metrics, the user can click save button 865. At that point, the metrics are stored in a structured format (e.g., row/column) in the corresponding file or database, and the newly updated information can be displayed by GUI 850. Any changes made to the metrics manually by the user can be used to fine-tune the transformation model which can help improve the accuracy of future results. The extracted company metrics are displayed on the left side of the screen and can be ordered in sequential order or grouped by metric type (e.g., email, meeting notes, etc.).

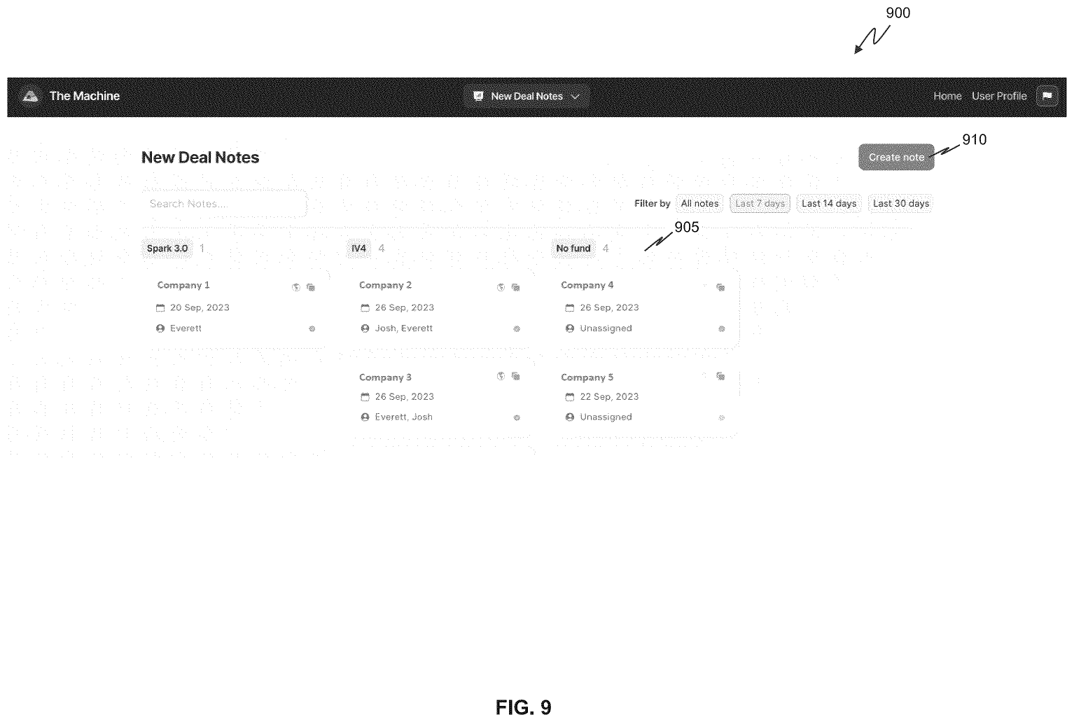

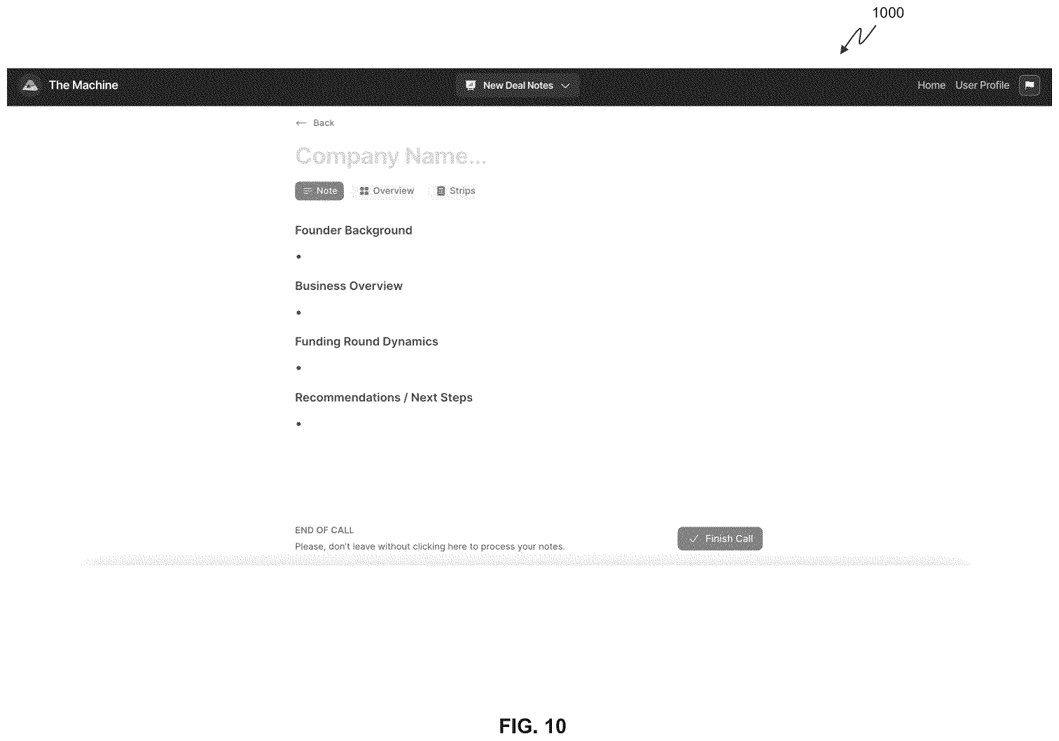

FIG. 9 depicts an exemplary on-screen GUI 900 showing deal notes for various companies categorized including non-portfolio companies 905 according to embodiments of the present invention. A specific company can be selected to view the notes and information recorded for that company. To enter a new note, the user can select create note button 910. FIG. 10 depicts an exemplary on-screen GUI 1000 for entering a new note. In the example of FIG. 10, a new deal note is entered for a non-portfolio company (a company the firm or user is not currently invested in) according to embodiments of the present invention. GUI 1000 can be structured to include different categories as desired, including founder background, business overview, funding round dynamics, and recommendations/next steps, as depicted in FIG. 10. Different note types can be drafted, including new deal or company notes, existing portfolio company notes, miscellaneous notes (which may not be associated with a specific company), notes associated with venture capital firms, etc.

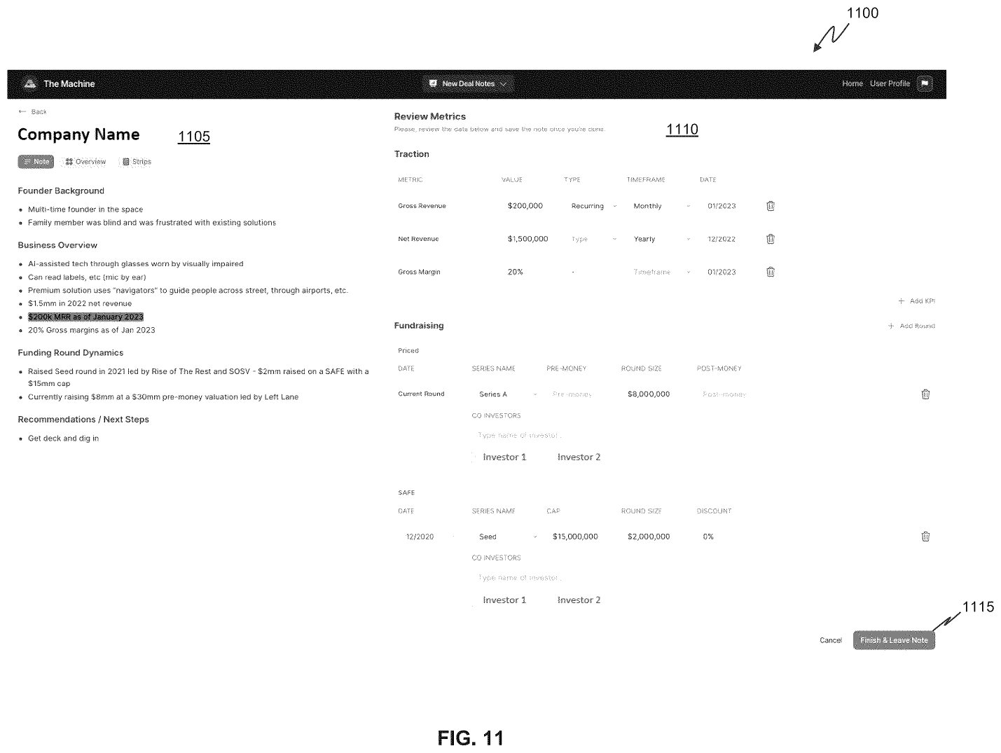

FIG. 11 depicts an exemplary on-screen GUI 1100 displaying submitted and processed meeting note information according to embodiments of the present invention. The meeting note can pertain to a new non-portfolio company, or an existing portfolio company, for example. As described above, a user can hover over the metrics shown on the right pane 1105, and the portion of the note that the metrics were gathered from is highlighted on the left pane 1110. According to embodiments, the extraction algorithm can identify not only the type of metric (e.g., revenue, cash on hand, etc.) but also the time period the metric is referring to, as well as information relating to current and past fundraising rounds. The user can also quickly and easily review the extracted metrics and can make any corrections that might be needed before saving the note, and the corrections can be used to fine-tube the extraction/transformation algorithm. Once a user is satisfied with the returned metrics, they can click finish and leave note button 1115 to save and submit the note to the corresponding database in a structured format (e.g., row/column). The metrics are also added to a ‘Marketplace Dashboard’ view that allows the firm to glean key insights on the market based on the extracted metrics over time.

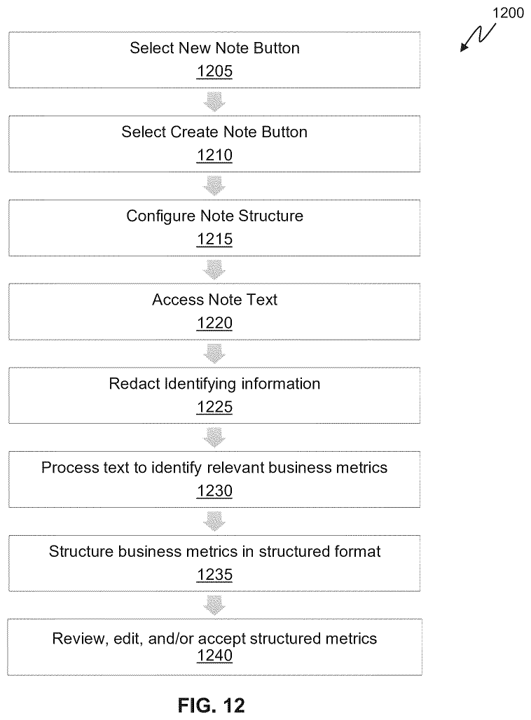

FIG. 12 is a flowchart depicting steps of an exemplary process 1200 for automatically structuring data from meeting notes pertaining to non-portfolio companies according to embodiments of the present invention. Many firms have meetings with many companies they do not ultimately invest in. However, the information gathered via these may be very useful to firms to understand how private markets are trending (e.g., what types of companies are being funded, what price are they being funded at, trending companies, etc.). However, when the information is not stored in a structured format, it becomes difficult and time consuming to parse this information for spotting broader trends and patterns. Advantageously, embodiments of the present invention can extract useful data points from all meeting notes to make those important insights more easily understandable.

Specifically, at step 1205, a user selects the new note button or page of an on-screen graphical user interface. The GUI then shows all non-portfolio notes taken over various time periods, which are selectable by the user (see FIG. 9). At step 1210, the user selects the create note button to start a new note, which opens a new note interface (see FIG. 10). At step 1215, a user can optionally configure a custom note-taking structure including any number of categories. To save and submit the entered information, the user can select a finish meeting button displayed on the UI. At this point, at step 1220, the text from the note is accessed and prepared for processing. At step 1225, any identifying information about the company can be removed. At step 1230, the remaining text is processed using a fine-tuned LLM or other AI-driven transformation engine to identify any relevant business metrics, such as key metrics and funding information. At step 1235, the identified information is organized in a structured format and stored in a database or repository. The processed metrics can then be displayed on a GUI disclosed herein, for example. At step 1240, the structured metrics are reviewed for any necessary changes, and the metrics can be manually edited for accuracy. The editing can be performed using a split-screen graphical user interface that also shows existing company metrics before they are accepted and added to the database, according to embodiments.

### Exemplary Computer Controlled System

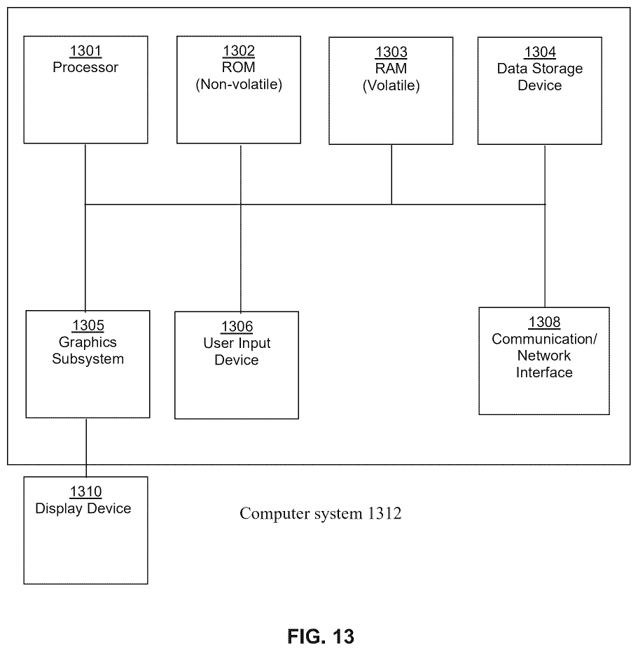

Embodiments of the present invention are drawn to systems and methods of company information parsing and processing performed automatically using a computer system. The company information can be accessed from an email or meeting note for example, and the textual information thereof can be parsed to identify important company information which can then be translated into structured (e.g., row/column) data. The data can be stored in a database, optionally replacing or updating existing data, and later displayed on a graphical user interface rendered on a display device. One exemplary computer system for deal flow management is described below with respect to FIG. 13.

In the example of FIG. 13, the exemplary computer system 1312 includes a central processing unit (such as a processor or a CPU) 1301 for running software applications and typically an operating system. Read-only memory 1302 and random-access memory 1303 store applications and data for use by the CPU 1301. Data storage device 1304 provides non-volatile storage for applications and data and may include fixed disk drives, removable disk drives, flash memory devices, and CD-ROM, DVD-ROM or other optical storage devices. The optional user input 1306 comprises devices that communicate inputs from one or more users to the computer system 1312 (e.g., mice, joysticks, cameras, keyboards, touch screens, and/or microphones). A communication or network interface can be used to communicate electronically with a local and/or remote computer network, such as the Internet.

The display device 1310 may be any device capable of displaying visual information in response to a signal from the computer system 1312. The components of the computer system 1312, including the CPU 1301, memory 1302/1303, data storage 1304, user input devices 1306, and optional graphics subsystem 1305 may be coupled via one or more data buses. Data storage 1304 can be used to store a database, file, or spreadsheet of processed and/or structured company information.

Embodiments of the present invention are thus described. While the present invention has been described in particular embodiments, it should be appreciated that the present invention should not be construed as limited by such embodiments, but rather construed according to the following claims.

What is claimed is:

1. A method for automatically structuring textual information of a meeting note, the method comprising:
accessing text of a meeting note;
processing the text using an AI-driven translator to identify business metrics of the text;
after the processing, parsing the text into a structured format comprising a plurality of metrics; and
displaying the plurality of metrics on an on-screen graphical user interface rendered on a display device, wherein the on-screen graphical user interface automatically updates the plurality of metrics when new meeting notes are submitted and processed.

2. The method of claim 1, wherein the text comprises information acquired during a meeting with a company, wherein the text is manually entered by a user, and wherein the business metrics comprise metrics associated with the company.

3. The method of claim 1, wherein the text comprises identification information that identifies a particular company, and further comprising redacting the identification information from the text of the meeting note before the text is processed.

4. The method of claim 1, further comprising:
receiving error correction input from a user to correct an error of the text after the processing; and
replacing an item of the text using the error correction input to correct the error.

5. The method of claim 4, further comprising fine tuning the AI-driven translator using the error correction input.

6. The method of claim 5, wherein the AI-driven translator comprises a machine learning (ML) algorithm.

7. The method of claim 6, further comprising fine tuning the ML algorithm using company data and error correction data.

8. The method of claim 6, further comprising fine tuning the ML algorithm using upcoming fundraising round information.

9. The method of claim 1, wherein the structured format comprises a row and column format.

10. The method of claim 1, wherein the plurality of metrics comprise at least one of: revenue; cash on hand; and burn rate.

11. A method for automatically structuring textual information of a company update email, the method comprising:
accessing text of a company update email;
forwarding the company update email to a designated email address;
receiving the company update email at the designated email address;
processing the text using an AI-driven translator to identify business metrics of the text;
after processing, parsing the text into a structured format comprising a plurality of metrics; and
displaying the plurality of metrics on an on-screen graphical user interface rendered on a display device, wherein the on-screen graphical user interface automatically updates the plurality of metrics when new company update emails are received and processed.

12. The method of claim 11, further comprising sending an email comprising a link to the plurality of metrics.

13. The method of claim 11, wherein the text comprises identify information that identifies a particular company, and further comprising redacting identifying information from the text of the company update email before the text is processed.

14. The method of claim 11, further comprising:
receiving error correction input from a user to correct an error of the text after the processing; and
replacing an item of the text with the error correction input to correct the error.

15. The method of claim 14, further comprising fine tuning the AI-driven translator using the error correction input.

16. The method of claim 15, wherein the AI-driven translator comprises machine learning algorithm (ML).

17. The method of claim 16, further comprising fine tuning the ML algorithm using company data and error correction data.

18. The method of claim 16, further comprising fine tuning the ML algorithm using upcoming fundraising round information pertaining to a company.

19. The method of claim 12, wherein the accessing text of a company update email comprises accessing text of an email attachment of the company update email.

20. A computer system, comprising:
a processor; and
a memory coupled to the processor, wherein the memory is operable to store company metrics, wherein the processor is operable to perform a process of structuring textual information of a meeting note to generate structured meeting note information, the method comprising:
accessing text of the meeting note entered by a user;
processing the text using an AI-driven translator to identify company metrics of the text; and
after processing, parsing the text into a structured format comprising a plurality of metrics.

21. The computer system of claim 20, further comprising a display device coupled to the processor, wherein the display device is operable to render an on-screen graphical user interface (GUI) according to instructions received from the processor, wherein the on-screen GUI comprises:
a first on-screen area operable to display the textual information of the meeting note entered by the user; and
a second on-screen area operable to display structured meeting note information comprising company metrics corresponding to the textual information, wherein interacting with an item of the textual information causes a corresponding item of the structured meeting note information to be highlighted.
